(19) United States
(12) Patent Application Publication
(10) Pub. No.: US 2026/0146662 A1
(43) Pub. Date: May 28, 2026

(54) Method and System for Indirectly Detecting Wear of a Cable Guide Device or Energy Chain

(71) Applicant: Igus GmbH, Köln (DE)

(72) Inventors: Dominik Barten, Meckenheim (DE); Andreas Hermey, Hennef (DE); Richard Habering, Köln (DE); Thilo-Alexander Jaeker, Sankt Augustin (DE)

(21) Appl. No.: 18/859,260

(22) PCT Filed: Apr. 3, 2023
(86) PCT No.: PCT/EP2023/058699

§ 371 Date: Oct. 23, 2024

(30) Foreign Application Priority Data
Apr. 25, 2022 (DE) 10 2022 109 963.6

(51) Int. Cl. F16G 13/16; F16G 13/18

(52) U.S. Cl. CPC F16G 13/16; F16G 13/18

(57) ABSTRACT

A method and a system monitors a cable guide device (10; 20; 30) for guiding at least one line between a stationary fixed point (2) and a driver (4) which can be moved relative thereto. The system (100; 200; 300) includes a sensor assembly (110; 210; 310) and an analysis device (120; 220; 320) connected to the sensor assembly. The sensor assembly contactlessly detects the position of the cable guide device (20) and generates an output on the basis thereof. In the event of a self-supporting upper strand (12), the sensor assembly (110; 210) detects the strand slack (TD) and generates the output on the basis thereof; or in the event of a sliding upper strand (32), the sensor assembly (310) detects the upper strand slack length (TH1, TH2) and/or the strand slack (TD) in the region of the strand slack length (TH1, TH2) and generates the output on the basis thereof.

The invention relates in general to a system and a method for monitoring a displaceable or dynamic line guide, such as for example an energy guide chain, for guiding at least one line, such as for example a cable, hose or the like, between a stationary fixed point and a moving end movable relative thereto, typically on a movable plant or machine part. The invention relates, in particular, to a system and a method for detecting wear during operation of the line guide apparatus or energy guide chain, to enable predictive maintenance.

When displaced, the line guide apparatus or energy guide chain typically forms a stationary lower run, a displaceable upper run and a co-traveling deflection arc therebetween. With such dynamic line guides, a distinction may, in particular, be drawn between two fundamental applications or types of arrangement.

On the one hand, line guide apparatuses are known which have a self-supporting upper run, i.e., configurations in which, during displacement, the upper run does not lie, or indeed glide or roll, on the lower run over its entire displacement path. This configuration is typically used for relatively short displacement paths, for example <10 m, and requires the upper run to have an appropriate load-bearing capacity over the desired self-supporting length.

On the other hand, if the self-supporting length is insufficient and/or, in particular, in the case of long displacement paths of a few tens of meters to a few hundred meters, in practice typically >>10 m, energy guide chains with a gliding upper run are generally used.

Applications with a gliding upper run are understood as those in which, on displacement at least along a sub-portion of the displacement path, the upper run travels as intended resting in each case in places on the lower run and/or on a glide support, for example “glide bars” on a guide trough. The upper run may in this case glide on the lower run or the glide support, for example by way of special skids, or indeed roll thereon if the energy guide chain has track rollers for reducing friction or increasing maximum distances.

Monitoring systems are already known which have a sensor assembly and an evaluator, which latter is connected for signaling with the sensor assembly, the sensor assembly contactlessly detecting a position of the line guide apparatus or energy guide chain and generating an output as a function thereof which the evaluator evaluates. Various systems of this general design have already been described in WO 2018/115449 A 1 and WO 2018/115528A 1. These solutions are designed primarily and in principle to monitor proper movement behavior of the line guide apparatus or energy guide chain when in operation.

For wear detection specifically, solutions are moreover known in which particular sensor modules are built into the line guide apparatus or energy guide chain, as proposed for instance in WO 2017/129805 A 1 or WO 2019/201482A 1. However, these solutions require structural changes to the energy guide chain and available installation space in the interior receiving space for the lines. A further approach to wear monitoring is proposed in WO 2021/043668A 1, but here too structural measures affecting the energy guide chain are required; indeed, this approach is suitable only for gliding energy guide chains with glide pads.

What is desired is a structurally simple solution for detecting wear during operation of different line guide apparatuses or energy guide chains which is maximally versatile in terms of use and can be implemented as far as possible without structural measures, or modifications or changes, with an existing line guide apparatus or energy guide chain. The solution is also intended to be suitable for line guides which are not actual energy guide chains, with chain links and receiving space for lines situated therewithin.

A first object of the invention is therefore to propose such a solution. This object is achieved by a method and a system according to claim 1 or 2 and, independently thereof, by an assembly according to claim 13, specifically in the case of a line guide apparatus for cleanroom applications.

A first aspect of the invention thus proposes, for a method (procedure) or system according to the preamble of claim 1 or 2, that
in the case of a self-supporting upper run, the sensor assembly detects run sag or is arranged and configured technically appropriately for this purpose and, as a function thereof, generates one or more outputs, for example digital or analog signals; or
in the case of a gliding upper run, the sensor assembly detects a run hanging length (corresponding to the length over which the upper run hangs freely between the deflection arc and a contact point between the upper run and the lower run) and/or run sag over the hanging length or is arranged and configured technically appropriately for this purpose and, as a function thereof, generates one or more outputs, for example digital or analog signals.

This sensor assembly design, which is structurally easy to implement, in particular without design measures having to be undertaken on the line guide, by itself allows indirect wear detection.

The invention is based namely on the practical recognition that “upper run tension” or the load-bearing capacity of the upper run deteriorates with increasing wear or increasing age and on the core concept of making technical use of precisely this change for state or wear detection.

To this end, for the purpose of indirect wear detection, the evaluator can evaluate the output(s) of the sensor assembly to check the detected run sag or the detected run hanging length when a predeterminable critical extent is reached and output a corresponding report. This may, in particular, be used as a maintenance report directed at predictive maintenance, such that, in the event of critical deterioration of the upper run tension or load-bearing capacity of the upper run being detected, maintenance may be undertaken in good time and machine or plant failure can be avoided.

Sagging of a self-supporting upper run may, in particular, reach a critical level if the sagging, corresponding to the degree to which the self-supporting upper run sags relative to a horizontal extended position in which the upper run runs horizontally in a straight line from the deflection arc, has become markedly greater than the structural height of the line guide, in particular of the chain links, and in particular if it falls below the intended radius of the deflection arc. This may result, among other things, in critical oscillations during to-and-fro motion of the upper run, with the risk of breakage of the line guide increasing significantly.

In the case of a gliding upper run too, wear phenomena, including for example in the hinge and pin joint of typical chain links, likewise lead wholly typically to deterioration of the upper run load-bearing capacity or upper run tension. As practical testing has shown, this is technically reliably detectable and ascertainable in the region of the somewhat backwardly curved transition by way of which the upper run transitions in self-supporting manner from the deflection arc to the contact point between the upper run and the lower run.

A critical threshold may here be determined empirically, depending on chain type, and expressed, for example, in the number of chain links (still) remaining hanging free at the point of transition. A conclusion of critical wear may for example be drawn if the run hanging length has fallen to less than ¾ or less than ⅔ of the original number of links or length when new, or a correspondingly proportional reduction in hanging length is otherwise identified, for example by length measurement. The horizontal length above which the transition from deflection arc to contact point (still) remains free hanging may, for example, also be considered for this purpose.

In the simplest form, suitable detection or measurement may be limited in all embodiments considered here to identification of a critical state, e.g., to identifying or testing whether a length or distance falls below or exceeds specific values.

Assessment of critical wear in a gliding upper run on the basis of run hanging length, i.e., the length over which the upper run extends in free hanging manner between deflection arc and contact point, may relate to this length as such or to a dimension proportional thereto and/or also to run sag over this transitional region, i.e., vertical sag in the region of the run hanging length.

One advantageous embodiment provides for the sensor assembly and/or the evaluator to be configured to detect the displacement direction and/or displacement motion of the line guide apparatus or energy guide chain, and for the evaluator to be accordingly configured to undertake evaluation of the output in particular as a function of direction or motion. The travel motion or travel direction can be communicated to the evaluator for example by signaling from the plant or machine control system of the plant or machine being supplied by the line guide.

Also advantageous is a connection with a force measurement at the moving end, as proposed for example in WO 2013/156607A 1, such that evaluation of the output(s) relating to run sag or run hanging length may optionally also proceed as a function of the tensile or thrust force currently being transmitted to or by the line guide.

The instantaneous travel direction and force transmission may influence run sag or run hanging length and thus also be taken into account in the computational evaluation.

The invention, in particular, provides automatic, automated detection of run sag and/or run hanging length during ongoing operation of the line guide, for example using suitable sensor systems and information technology.

In one particularly simple embodiment, the sensor assembly has at least one sensor or sensing component, which is arranged stationarily, when viewed in the longitudinal direction of the displacement path, in at least one longitudinal portion, predefined as a detection region, along the displacement path.

In the case of a self-supporting upper run, the detection region may preferably lie in the longitudinal portion between the fixed point and the fully advanced position of the moving end, in particular in the half facing the fixed point of the section between fixed point and fully advanced position of the line guide.

In the case of a gliding upper run, in particular in the case of an energy guide chain for long displacement paths, the detection region may preferably lie in the longitudinal portion between the fixed point and the fully drawn-in or retracted position of the moving end (position in which the upper run is optionally not in contact or only over a minimal length), in particular in the region of around ±10% of the path length either side of the position in which the moving end has traveled roughly 25% of the displacement path from the fully retracted position to the fully advanced position.

Different suitable arrangements may be considered in the vertical direction. For instance, the sensor assembly may comprise at least one distance sensor oriented in the displacement plane and, in particular, vertically relative to the displaceable upper run.

An ultrasonic distance measuring instrument and/or a laser distance measuring instrument, with which the evaluator is preferably compatible, may preferably be used as the distance sensor, these being inexpensively available, being conventional commercial technology, optionally also with a suitable interface for connection to a conventional bus system for industrial devices.

Furthermore, to simplify installation, provision may be made, in particular in the case of a self-supporting upper run, for the distance sensor to be oriented vertically upward in order to detect run sag. One or more distance sensors may preferably be attached to the support for the lower run in the direction of the advanced position next to the fixed point or at a distance from the fixed point.

The sensor assembly may have a plurality of sensors embodied and/or arranged identically or differently, for example distributed in the detection region along the route of the upper run. A plurality of sensors increase detection reliability, and for example enable detection of the travel direction.

In a further embodiment, in particular in the case of a gliding upper run, at least one distance sensor may be oriented vertically downward, in particular in order to detect the run hanging length by way of run sag. To this end, a corresponding distance sensor may preferably be arranged on a carrier or frame at a distance from the fixed point in the direction of the retracted position. Such an arrangement is preferably used with a further sensing component or sensor which detects passage of the deflection arc and triggers instantaneous measurement of run sag as a function of the position of the deflection arc.

In the case, in particular, of a gliding upper run, the sensor assembly may have a number of sensing components along the displacement path in a longitudinal portion predefined as a detection region, these being distributed in the displacement direction and being oriented horizontally relative to the energy guide chain in order to detect run hanging length. In this case, the sensing components/sensors may preferably be attached in a vertical direction preferably above the lower run and/or attached to a guide trough, in particular at the level of the gliding upper run or in a height region above the gliding upper run and below the top of the deflection arc, in particular below a horizontal travel plane of the notional deflection axis of the deflection arc or roughly at the height thereof. In this case, particularly simple proximity sensing components may be used, for example light barriers, or capacitive or inductive proximity switches, which are arranged spaced, for example by predetermined distances in the longitudinal direction.

In one embodiment, the sensor assembly may comprise at least two sensing component groups with in each case at least one, preferably multiple sensing components, wherein the sensing component groups are arranged spaced by a horizontal distance in such a way that two adjacent sensing component groups simultaneously detect, in the case of an as-new run hanging length, on the one hand the hanging upper run and on the other hand the deflection arc, while, in contrast, in the case of a critical run hanging length, the adjacent sensing component groups are no longer able to detect upper run and deflection arc simultaneously.

The sensor assembly may comprise a plurality of identically constructed sensors or sensing components, wherein the evaluator is configured accordingly to evaluate a plurality of outputs for checking detected run sag or detected run hanging length once a critical extent has been reached. In this way, more robust identification may be implemented, for example by ruling out instances of false detection or sensor faults. Cross-checking and/or a tolerance meter, for example with summation of detected critical states, and preferably reduction in the event of newly detected normal cases, whose meter reading is compared with a threshold value, can be implemented in the evaluator, for example computationally or by suitable programming, in order to avoid a false maintenance report.

In principle, sensor assembly and evaluator are preferably configured such that run sag or run hanging length are fully automatically detected during ongoing operation and the evaluator evaluates the corresponding outputs fully automatically in ongoing manner for the purpose of indirect wear detection. This ongoing evaluation may proceed at a single selected position along the displacement path, i.e., in each case at the point in time that the upper run travels to or fro past this position. Alternatively and/or in addition, detection may also proceed when the line guide apparatus is at a standstill.

The evaluator preferably has at least one programmable processor which is programmable for the desired evaluation. The evaluator preferably has at least one storage device, in which an application-specific predetermined limit value for a critical degree of run sag or of run hanging length has been or is stored. The limit value may in particular be predetermined computationally, empirically (by testing) or by training on start-up of an as-new line guide apparatus or energy guide chain.

Furthermore, the evaluator preferably has a communication interface or is connected with an interface, which is configured for communication with a plurality of different network environments and/or bus systems. The evaluator may, for example, be connected to the sensor assembly via a conventional industrial bus and at the same time may have a link to a higher-level cloud storage system, for example via LAN or WLAN connection or the like.

According to a further, independent aspect, an assembly is proposed specifically for monitoring a line guide apparatus for cleanroom applications.

This comprises a line guide apparatus for protected guidance of supply lines, such as cables, hoses or the like, between two connection points, of which at least one is mobile relative to the other, the line guide device having a longitudinal direction and being displaceable to and fro, forming a stationary lower run, a displaceable upper run and a deflection arc therebetween, and having a flexible envelope, in particular a low-friction envelope closable in dust-tight manner, with at least one receiving channel or a number of receiving channels arranged next to one another and extending in the longitudinal direction in each case for at least one supply line or for a support chain, the line guide device being embodied and arranged with a self-supporting upper run.

According to this aspect, the line guide apparatus is distinguished in that a sensor assembly is provided with at least one sensor or sensing component which detects run sag, corresponding to the vertical extent to which the self-supporting upper run is sagging relative to a horizontal extended position, and generates an output as a function thereof.

Such line guide apparatuses for cleanroom applications are proposed for example in WO 2016/042134A1, or indeed in WO 2020/148300 A1 or WO 2020/148596A1.

In such cases, with a line guide apparatus of this type, a support chain may in each case be provided, optionally or in particular in at least one or in particular in at least two receiving channels, said support chain predefining the deflection arc and being provided to support the self-supporting upper run. A support chain of this type was proposed by the applicant in WO 2021/116467A1, for example. In accordance with the above-mentioned core concept, the proposed sensor assembly may in this case also detect indirect wear to the line guide apparatus, in particular to support chains accordingly provided therein.

The above-explained features relating to the first aspect can likewise be advantageously combined with the second aspect.

Further details and advantages of the individual aspects of the invention may be inferred, without restricting the general nature of the above, from the following explanation of preferred exemplary embodiments on the basis of the appended drawings. Features of corresponding or identical structure or function have corresponding reference signs and may not be repeatedly described. In the drawings:

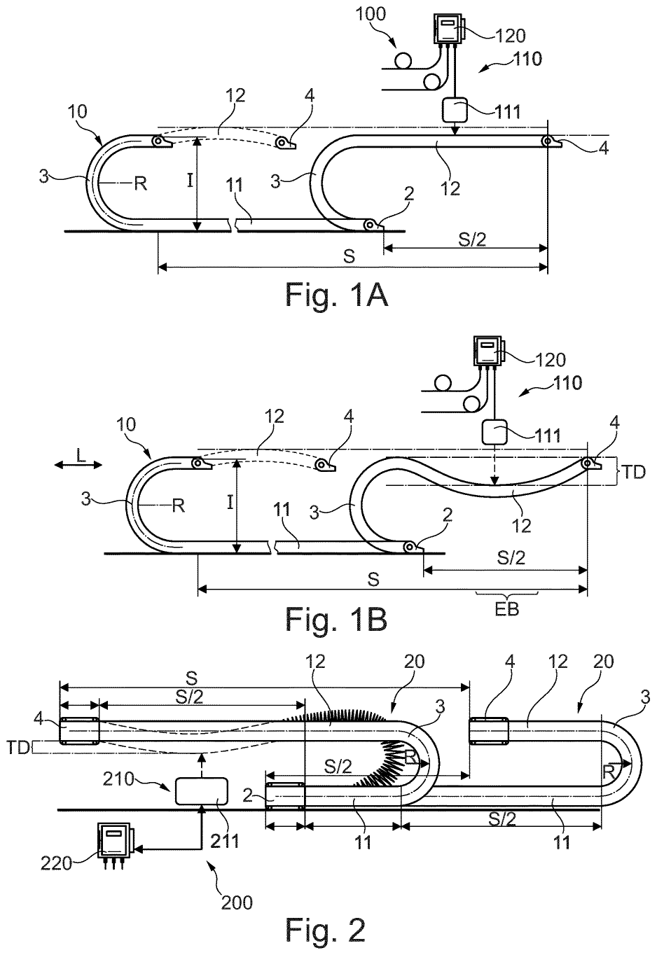

FIGS. 1A-1B are a schematic side view of a conventional energy guide chain with a self-supporting upper run, with the upper run in the extended position (FIG. 1A) and with critical upper run sag (FIG. 1B), wherein the energy guide chain is equipped with a system for indirect wear detection according to a first exemplary embodiment of the invention;

FIG. 2 is a schematic side view of a line guide device for cleanroom applications, with a system for indirect wear detection according to a second exemplary embodiment of the invention, in both end positions of the line guide device (fully advanced on the left in FIG. 2, fully retracted on the right in FIG. 2); and

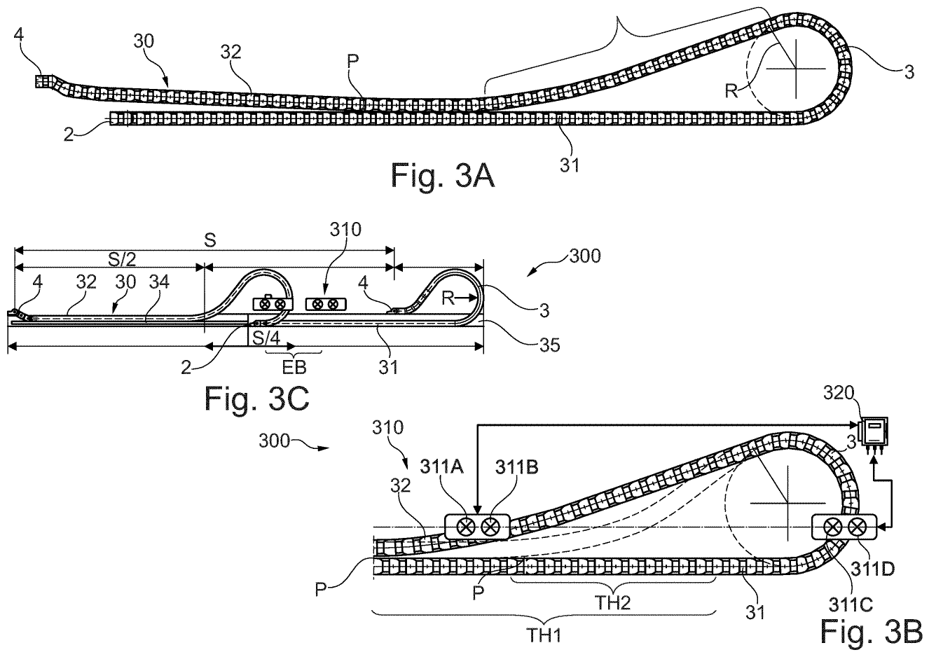

FIGS. 3A-3C are schematic side views of an instantaneous position of a conventional energy guide chain with gliding (or rolling) upper run (FIG. 3A) for long displacement paths, which is equipped with a system for indirect wear detection (magnified in FIG. 3B) according to a third exemplary embodiment of the invention, and a full schematic side view (FIG. 3C) of a preferred detection region for arranging the sensor assembly along the displacement path.

FIGS. 1A-1B show a line guide apparatus, here an energy guide chain 10 of per se known design, for guiding lines (not shown) between a stationary fixed point 2 and a moving end 4 movable relative thereto. The energy guide chain 10 travels, with the here linear and horizontal motion of the moving end 4, in the travel direction L over the displacement path S. The energy guide chain 10 forms a stationary lower run 11 and a displaceable upper run 12 as it travels. The energy guide chain 10 is deflected or turned back between the runs 11, 12 in a deflection arc 3 with the radius R, which travels with the moving end 4 at half the speed thereof. In FIGS. 1A-1B, the energy guide chain 10 is embodied to be self-supporting, i.e., with a self-supporting upper run 12 which is not intended to rest on anything.

FIGS. 1A-1B furthermore show schematically a system 100 for indirect wear monitoring, with a sensor assembly 110 and an evaluator 120 connected therewith by signaling.

As illustrated in FIG. 1B, the sensor assembly 110 is arranged and configured to detect the run sag TD of the energy guide chain 10 contactlessly and to transmit a corresponding output to the evaluator 120, which evaluates the output as to whether a critical degree of run sag TD (roughly as shown in FIG. 1B) has been reached. If this is detected, the evaluator 120 outputs a corresponding report via a suitable interface (not shown). This may in particular be a maintenance report or maintenance recommendation intended for predictive maintenance, said report or recommendation being transmitted to a higher-level system, for example a cloud solution, an overarching monitoring or IoT network or the like.

The evaluator 120 may here be configured to detect the displacement direction and/or displacement motion of the energy guide chain 10, and to undertake evaluation of the signals from the sensor assembly 110 in particular as a function of direction or motion. To this end, the evaluator 120 may be connected to the control system (not shown), for example via a bus system.

The sensor assembly 110 comprises a distance sensor 111, for example an ultrasonic distance measuring instrument and/or a laser distance measuring instrument, which in FIGS. 1A-1B is oriented vertically downward in order to measure run sag TD instrumentally and to transmit to the evaluator 120 an output in the form of a detected measured value for the measured distance indicating the run sag TD. The distance sensor 111 is arranged in the longitudinal portion from the fixed point 2 to the fully advanced position S of the moving end 4, in particular in the half facing the fixed point 2 of the section between fixed point 2 and fully advanced position S.

FIG. 2 differs from the exemplary embodiment according to FIGS. 1A-1B substantially in two aspects. The line guide in the example shown in FIG. 2 is a line guide apparatus 20 for cleanroom applications, as proposed for example in WO 2016/042134A1, or indeed in WO 2020/148300 A1 or WO 2020/148596A1, the teaching of which is referred to by reference for the sake of brevity. The line guide apparatus 20 may be embodied with or without support chains, for example with support chains according to WO 2021/116467A1, the teaching of which is referred to by reference for the sake of brevity.

The line guide apparatus 20 is likewise intended to be provided with a self-supporting upper run 12. In FIG. 2, a similar detection principle is used for monitoring run sag TD. As in FIGS. 1A-1B, a sensor assembly 210 is provided which also has, in FIG. 2, at least one distance sensor 111, 211 oriented in the displacement plane and, in particular, vertically relative to the displaceable upper run 12. In FIG. 2 too, the distance sensor 211 can be designed as an ultrasonic distance measuring instrument and a laser distance measuring instrument. In FIG. 2, in contrast, the distance sensor 211 is oriented vertically upward, in order to detect or measure current run sag TD. The distance sensor 211 may in this case be mounted without particular effort on a support on which the lower run 11 is placed and on which the end connection is fastened to the fixed point 2. The distance sensor 211 is attached in the direction of the advanced position S close to the fixed point 2 or at a distance therefrom, depending on the length of the line guide apparatus 20 and the location at which sag is most to be expected, typically roughly halfway along the upper run between the deflection arc 3 and the end position S of the fully advanced moving end 4 (on the left in FIG. 2). The arrangement of FIGS. 1-2 enables structurally simple and thus inexpensive continuous monitoring of the current sag of the energy guide chain 10 or of the line guide apparatus 20. As soon as a critical state of the energy guide system is identifiable, the evaluator 120, 220 may output predictive maintenance recommendations.

FIGS. 3A-3C show the case of an energy guide chain 30 for long displacement paths with a gliding upper run 32, which, depending on the position of the traveling moving end 4, glides or rolls on the lower run 31 and/or on glide bars 34 in a per se known guide trough 35 (FIG. 3C). FIG. 3A shows by way of example a position of the energy guide chain 30 with the moving end 4 roughly half extended S/2, at which position the upper run 32 initially merely glides or rolls on the lower run 31 before transitioning toward the fully advanced position S on glide bars 34. Between the deflection arc 3 and the contact point P of the upper run 32 on the lower run 31, there is a transitional region 37 over which the upper run 32 hangs free from the deflection arc 3 to the contact point P. With increasing wear and tear, the length, known here as run hanging length, of the transitional region 37 decreases, which can also be represented or detected by way of the distance TH1 or TH2 (cf. FIG. 3C) between contact point P and deflection arc 3. This is utilized according to the invention, for a gliding energy guide chain 30, for indirect and preventive wear monitoring, as will now be explained on the basis of FIGS. 3B-3C.

As shown in FIG. 3B, a sensor assembly 310 is provided which is configured to detect a run hanging length TH1, TH2 corresponding to the length of the transitional region 37 and generate outputs or signals as a function thereof which are transmitted to an evaluator 320 of suitable configuration. In this exemplary embodiment, the sensor assembly 310 comprises simple light barriers or, for example, capacitive proximity switches, which are oriented horizontally and perpendicularly relative to the displacement plane of the energy guide chain 30.

As FIG. 3C shows, the sensor assembly 310 has a plurality of identically constructed sensors or sensing components 311A-311D and the evaluator 320 is configured accordingly to evaluate a plurality of outputs for checking the detected run hanging length TH1, TH2 when a critical level is reached. The sensor assembly of FIG. 3C has two sensing component groups with in each case two sensing components 311A-311B and 311C-311D, respectively, arranged spaced horizontally. The distance may, for example, be selected such that, in the case of an as-new run hanging length TH1, all the sensing components 311A-311B and 311C-311D, respectively, simultaneously on the one hand detect the hanging upper run 32 or the transitional region 37 thereof and at the same time on the other hand detect the deflection arc 3. If the distance is suitably set, upper run 32 and deflection arc 3 may be detected by just one or the other of the two sensing component groups 311A-311B or 311C-311D, for example in the event of a critical run hanging length, rather than by all of 311A-311B and 311C-311D simultaneously. It is thus possible to reliably conclude that sag is at a critical level or a that the run hanging length TH2 has deteriorated excessively. Other configurations are also possible, with just precisely two sensing components or sensing component groups, such that all or a plurality of sensing components respond simultaneously only when the state is critical.

As FIG. 3C shows by way of example, it is generally possible for a number of sensing components 311A-311D to be arranged distributed in the displacement direction (L) along the displacement path in the predetermined longitudinal portion or detection region EB and oriented horizontally relative to the energy guide chain 30. This allows structurally simple implementation for detecting the run hanging length TH1, TH2. The sensing components 311A-311D may preferably be attached to the guide trough 35 above the lower run 31, in particular at the level of the gliding upper run 32, or in a height region above the gliding upper run 32 and below the top of the deflection arc 3, as shown in FIG. 3C.

As shown in FIG. 3B, the sensor assembly 310 is provided in spatially delimited manner in a detection region EB in the longitudinal portion from the fixed point 2 to the fully retracted position of the moving end 4, here roughly in the region of around ±10% of the path length S either side of the position in which the moving end 4 has traveled over about 25% of the displacement path, cf. S/4, from the fully retracted position (on the right in FIG. 3B) to the fully advanced position S (on the left in FIG. 3B). FIG. 3C is also a schematic representation of a guide trough 35 and the glide bars 34 provided therein, which latter are arranged aligned with the level of the top of the lower run 31.

### LIST OF REFERENCE SIGNS

10 Energy guide chain (with self-supporting upper run)
20 Line guide apparatus (for cleanroom applications)
30 Energy guide chain (with gliding upper run)
2 Fixed point
3 Deflection arc
4 Moving end
11; 31 Lower run
12 Self-supporting upper run
32 Gliding upper run
34 Glide bar
35 Guide trough
37 Transitional region
100; 200; 300 Monitoring system
110; 210; 310 Sensor assembly
111; 211 Distance sensor (for example ultrasonic distance measuring instrument)
120; 220; 320 Evaluator
311A, 311B, 311C, 311D Sensing components/proximity switches
EB Detection region
H Installation height
L Displacement direction
P Contact point (gliding upper run)
R Radius
S Displacement path
TD Run sag (vertical)
TH1, TH2 Run hanging length (optionally measured horizontally)

1. A method for monitoring a displaceable line guide apparatus (10; 20; 30) for guiding at least one line between a stationary fixed point (2) and a moving end (4) movable relative thereto, the line guide apparatus (20) having, during displacement, a stationary lower run (11; 31), a displaceable upper run (12; 32) and a deflection arc (3) therebetween,
wherein the monitoring is conducted by a monitoring system (100; 200; 300) comprising a sensor assembly (110; 210; 310) and an evaluator (120; 220; 320), which latter is connected for signaling with the sensor assembly (110; 210; 310), the sensor assembly (110; 210; 310) contactlessly detecting a position of the line guide apparatus (20) and generating an output as a function thereof which the evaluator evaluates,
wherein
the upper run (12) of the line guide apparatus (20) is embodied and arranged as a self-supporting upper run and the sensor assembly (110; 210) detects run sag (TD), corresponding to a vertical extent to which the self-supporting upper run (12) is sagging relative to a horizontal extended position (LG), and generates the output as a function thereof,
the upper run (32) of the line guide apparatus (20) is embodied and arranged as gliding upper run and the sensor assembly (310) detects a run hanging length (TH1, TH2), corresponding to the length over which the upper run (32) hangs freely between the deflection arc (33) and a contact point (P) between the upper run (32) and the lower run (31), and/or the run sag (TD) in the region of the run hanging length (TH1, TH2) and generates the output as a function thereof; and
wherein for the purpose of indirect wear detection, the evaluator (120; 220;

320) evaluates the output to check the detected run sag (TD) or the detected run hanging length (TH1, TH2) when a critical extent is reached and outputs a corresponding report.

2. A system for monitoring a line guide apparatus (10; 20; 30) for guiding at least one line between a stationary fixed point (2) and a moving end (4) movable relative thereto, the line guide apparatus (20) being displaceable, forming a stationary lower run (11; 31), a displaceable upper run (12; 32) and a deflection arc (3) therebetween, and
the system (100; 200; 300) comprising a sensor assembly (110; 210; 310) and an evaluator (120; 220; 320), which is connected for signaling with the sensor assembly (110; 210; 310), the sensor assembly (110; 210; 310) being arranged and configured to contactlessly detect a position of the line guide apparatus (20) and to generate an output as a function thereof, and the evaluator being arranged and configured to evaluate the output,
wherein
the line guide apparatus (20) is embodied and arranged with a self-supporting upper run (12) and the sensor assembly (110; 210) is arranged and configured to detect a run sag (TD), corresponding to the vertical extent to which the self-supporting upper run (12) is sagging relative to a horizontal extended position (LG), and to generate the output as a function thereof, or
the line guide apparatus is embodied and arranged with a gliding upper run (32) and the sensor assembly (310) is arranged and configured to detect a run hanging length (TH1, TH2), corresponding to the length over which the upper run (32) hangs freely between the deflection arc (3) and a contact point (P) between the upper run (32) and the lower run (32), and/or the run sag (TD) in the region of the run hanging length (TH1, TH2) and to generate the output as a function thereof; and
wherein the evaluator (120; 220; 320) is configured to evaluate the output to check the detected run sag (TD) or the detected run hanging length (TH1, TH2) when a critical extent is reached and to output a corresponding report.

3. The method according to claim 1, wherein the sensor assembly (110; 210; 310) and/or the evaluator (120; 220; 320) is configured to detect the displacement direction and/or displacement motion of the line guide apparatus (20), and evaluation of the output proceeds as a function of direction or motion.

4. The system according to claim 2, wherein the sensor assembly (110; 210; 310) comprises at least one sensor (111; 211; 311A-311D) or sensing component which is arranged stationarily in at least one longitudinal portion(ES), predefined as a detection region, along the displacement path.

5. The system according to claim 2, wherein the sensor assembly comprises at least one distance sensor (111; 211) oriented in the displacement plane and vertically relative to the displaceable upper run (12).

6. The system according to claim 5, wherein in the case of the self-supporting upper run (12), the distance sensor (211) is oriented vertically upward, in order to detect run sag (TD) and is attached to the support for the lower run in the direction of an advanced position next to the fixed point (2) or at a distance from the fixed point (2).

7. The system according to claim 5, wherein the distance sensor (111) is oriented vertically downward, in the case of the gliding upper run (32) to detect the run hanging length (TH1, TH2) by way of the run sag (TD).

8. The system according to claim 4 in the case of the gliding upper run (32), the sensor assembly (310) has a number of sensing components (311A-311D) along the displacement path in a longitudinal portion predefined as detection region (EB), these being distributed in the displacement direction (L) and being oriented horizontally relative to the energy guide chain (30) in order to detect run hanging length (TH1, TH2), the sensing components (311A-311D) are attached to a guide trough (35) and/or above the lower run (31), at the level of the gliding upper run (32) or in a height region above the gliding upper run (32) and below a top of the deflection arc (3).

9. The system according to claim 2, wherein the sensor assembly (310) comprises a plurality of identically constructed sensors or sensing components (311A-311D) and the evaluator (320) is configured accordingly to evaluate a plurality of outputs for checking detected run sag (TD) or detected run hanging length (TH1, TH2) once a critical extent has been reached.

10. The method according to claim 1, wherein the sensor assembly (110; 210; 310) fully automatically detects run sag or run hanging length during ongoing operation and the evaluator (120; 220; 320) evaluates the corresponding outputs fully automatically in ongoing manner for the purpose of indirect wear detection.

11. The system according to claim 2, wherein the evaluator (120; 220; 320) has a storage device, in which an application-specific predetermined limit value for a critical degree of run sag or of run hanging length has been or is stored.

12. The system according to claim 2, wherein the evaluator (120; 220; 320) has an interface or is connected with an interface, which is configured for communication with a plurality of different network environments and/or bus systems.

13. An arrangement for monitoring a line guide apparatus (20) for cleanroom applications, comprising:
a line guide apparatus for protected guidance of supply lines between two connection points, of which at least one is mobile relative to the other, the line guide device having a longitudinal direction (L) and being displaceable to and fro, forming a stationary lower run (11), a displaceable upper run (12) and a deflection arc (3) therebetween, and having a flexible envelope (22) with a number of receiving channels arranged next to one another and extending in the longitudinal direction in each case for at least one supply line or for a support chain, the line guide device being embodied and arranged with a self-supporting upper run (12); and
a sensor assembly (220) having at least one sensor or sensing component (221) which detects run sag of the upper run (12) relative to a horizontal extended position, and generates an output as a function thereof.

14. The arrangement with line guide apparatus according to claim 13, wherein said support chain is in at least one receiving channel, said support chain predefining the deflection arc and being provided to support the self-supporting upper run (12).

15. The arrangement with line guide apparatus according to claim 13, wherein the sensor assembly (110; 210; 310) and/or the evaluator (120; 220; 320) is configured to detect a displacement direction and/or a displacement motion of the line guide apparatus (20), and an evaluation of the output proceeds as a function of direction or motion.

16. The method according to claim 1, wherein the displaceable line guide apparatus (10; 20; 30) is an energy guide chain.

17. The system according to claim 2, wherein the evaluator (120; 220; 320) is configured to evaluate for the purpose of indirect wear detection.

18. The system according to claim 2, wherein the displaceable line guide apparatus (10; 20; 30) is an energy guide chain.

19. The system according to claim 4, wherein
in the case of the self-supporting upper run (12), the detection region lies in a longitudinal portion between the fixed point (2) and a fully advanced position of the moving end (4), in a half facing the fixed point (2) of the section between fixed point (2) and the fully advanced position (S);
in the case of the gliding upper run (12), the detection region lies in the longitudinal portion between the fixed point (2) and a fully retracted position of the moving end (4), in a region of around ±10% of a path length either side of a position in which the moving end has traveled roughly 25% of the displacement path (S/4) from the fully retracted position to the fully advanced position.

20. The system according to claim 5, wherein the distance sensor comprises an ultrasonic distance measuring instrument and/or a laser distance measuring instrument.
